(19) United States
(12) Patent Application Publication
(10) Pub. No.: US 2011/0122125 A1
(43) Pub. Date: May 26, 2011

(54) METHOD AND APPARATUS FOR DISPLAYING AND ARRANGING DATA 3-DIMENSIONALLY

(76) Inventor: Jin-Ho YOON, Seoul (KR)

(21) Appl. No.: 12/915,845

(22) Filed: Oct. 29, 2010

(30) Foreign Application Priority Data
Nov. 23, 2009 (KR) 10-2009-0112980

(51) Int. Cl. G06T 15/00

(52) U.S. Cl. 345/419

(57) ABSTRACT

A three-dimensional data displaying method includes: rendering a three-dimensional matrix image by arranging meta information representing data entries at coordinates composed of a horizontal axis component, a vertical axis component, and an azimuth component, based on arrangement information, with respect to structured data entries including the meta information and the arrangement information; and displaying the three-dimensional matrix on a screen. The meta information may include a topic word and a visual display, and the arrangement information may include a first classification attribute corresponding to the horizontal axis component, a second classification attribute corresponding to the vertical axis component, and a third classification attribute corresponding to the azimuth component.

### CROSS-REFERENCE(S) TO RELATED APPLICATIONS

The present application claims priority of Korean Patent Application No. 10-2009-0112980 filed on Nov. 23, 2009 which is incorporated herein by reference in its entirety.

### BACKGROUND OF THE INVENTION

1. Field of the Invention

The present invention relates to a data displaying method and apparatus, and more particularly, to a three-dimensional data displaying method and apparatus.

2. Description of Related Art

In general, when searching data from a database (DB) and displaying the search result on a monitor, a relevant application arranges and displays the search result on a screen on the basis of attributes. The criterion of the data arrangement is the attributes of the searched data.

For example, when books are searched in online, the searched books have attributes, such as titles, fields, authors, publishers, topics, dates of publication, and prices. A web server can arrange data of the searched data on the basis of attributes which are pertinently determined. Only cover images of the arranged books may be displayed on a screen, or supplementary information, such titles, authors, and prices, may be displayed on a screen together with the cover images.

Such a search result displaying method is to arrange the searched data on the basis of only one attribute. If a user designates other attribute and rearranges the searched data, the arrangement based on the previous attribute is discarded, and a new arrangement is provided. Therefore, it is difficult to quickly find a desired data from the search result. If the search result exceeds a volume that can be simultaneously displayed on a screen, a user has to scroll the screen several times or turn over a page several times.

Accordingly, there is a need for a method which can overcome the limitation of the conventional method for arranging and displaying the search result, display the search result on one page, and allow a user to easily select specific data from the displayed search result.

### SUMMARY OF THE INVENTION

An embodiment of the present invention is directed to a method and apparatus which can display a search result on one screen and allow a user to easily select specific data from the displayed search result.

In accordance with an embodiment of the present invention, a three-dimensional data displaying method includes: rendering a three-dimensional matrix image by arranging meta information representing data entries at coordinates composed of a horizontal axis component, a vertical axis component, and an azimuth component, based on arrangement information, with respect to structured data entries including the meta information and the arrangement information; and displaying the three-dimensional matrix on a screen.

The meta information may include a topic word and a visual display, and the arrangement information may include a first classification attribute corresponding to the horizontal axis component, a second classification attribute corresponding to the vertical axis component, and a third classification attribute corresponding to the azimuth component.

The three-dimensional data displaying method may further include: searching data; and processing the searched data into the structured data entries, based on the classification attributes of the searched data.

The processing of the structured data entries may include: extracting at least three classification attributes with respect to the searched data; extracting common upper-level concepts with respect to the extracted classification attributes; setting the classification attributes, which belong to two most common upper-level concepts among the extracted upper-level concepts, as first classification attributes corresponding to a horizontal axis component and second classification attributes corresponding to a vertical axis component; and setting the classification attributes, which belong to a plurality of partially common upper-level concepts among the remaining classification attributes, as a third classification attribute corresponding to an azimuth component.

The three-dimensional matrix may be visualized so that visual information among the meta information is disposed at the coordinates, and the three-dimensional data displaying method may further include displaying visual information and a topic word among the meta information on an auxiliary display area with respect to coordinates a user selects in the three-dimensional matrix.

In accordance with another embodiment of the present invention, a three-dimensional data displaying system includes: a matrix generation unit configured to allocate coordinates composed of a horizontal axis component, a vertical axis component, and an azimuth component, based on arrangement information, with respect to structured data entries including meta information and the arrangement information; and a three-dimensional display unit configured to render a three-dimensional matrix image by arranging the meta information representing the data entries at the coordinates.

The meta information may include a topic word and a visual display, and the arrangement information may include a first classification attribute corresponding to the horizontal axis component, a second classification attribute corresponding to the vertical axis component, and a third classification attribute corresponding to the azimuth component.

The three-dimensional data displaying system may further include an entry database including the structured data.

The three-dimensional data displaying system may further include: a search database; and a data structuring unit configured to process the searched data into the structured data entries, based on the classification attributes of the data searched from the search database.

The data structuring unit may be configured to extract at least three classification attributes with respect to the searched data, extract common upper-level concepts with respect to the extracted classification attributes, set the classification attributes, which belong to two most common upper-level concepts among the extracted upper-level concepts, as first classification attributes corresponding to a horizontal axis component and second classification attributes corresponding to a vertical axis component, and set the classification attributes, which belong to a plurality of partially common upper-level concepts among the remaining classification attributes, as a third classification attribute corresponding to an azimuth component.

The three-dimensional matrix may be visualized so that visual information among the meta information is disposed at the coordinates, and the three-dimensional data displaying system further may further include a two-dimensional display unit configured to display visual information and a topic word among the meta information on an auxiliary display area with respect to coordinates a user selects in the three-dimensional matrix.

In accordance with another embodiment of the present invention, a three-dimensional data displaying system includes: a server including a matrix generation unit configured to allocate coordinates composed of a horizontal axis component, a vertical axis component, and an azimuth component, based on arrangement information, with respect to structured data entries including meta information and the arrangement information; and a three-dimensional display unit configured to render a three-dimensional matrix image by arranging the meta information representing the data entries at the coordinates.

### BRIEF DESCRIPTION OF THE DRAWINGS

FIGS. 1A and 1B are exemplary diagrams illustrating a three-dimensional data display in accordance with an embodiment of the present invention.

FIGS. 2A, 2B and 2C are conceptual diagrams explaining the three-dimensional displaying method in accordance with the embodiment of the present invention.

FIG. 3 is an exemplary diagram illustrating the structure of data entry for the three-dimensional data display in accordance with the embodiment of the present invention.

FIG. 4 is an exemplary diagram illustrating the three-dimensional data matrix display and the two-dimensional auxiliary display in accordance with the embodiment of the present invention.

FIG. 5 illustrates exemplary display modes of the three-dimensional matrix in accordance with the embodiment of the present invention.

FIG. 6 is a flowchart illustrating a method for structuring searched data and generating a three-dimensional matrix in order for three-dimensional display in accordance with an embodiment of the present invention.

FIG. 7 is a schematic block diagram illustrating a three-dimensional data displaying system in accordance with an embodiment of the present invention.

FIG. 8 is a system diagram illustrating a three-dimensional mobile search data displaying system in accordance with an embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be constructed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

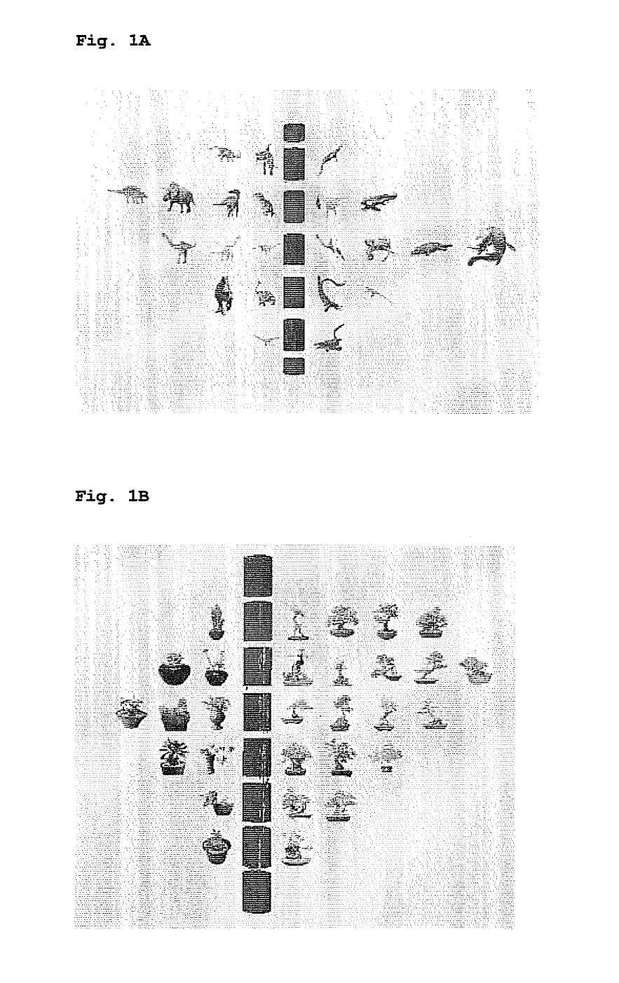

FIGS. 1A and 1B are exemplary diagrams illustrating a three-dimensional data display in accordance with an embodiment of the present invention.

Referring to FIGS. 1A and 1B, data searched from a specific DB or Internet or data having been previously arranged by a specific method are displayed on a screen in a three-dimensional matrix form.

In the three-dimensional matrix of the present invention, the respective data may be represented by a visual display, such as image icons or icons having a specific color or shape. As one example, when data to be displayed are related to persons, objects, or events, image icons representing the data may be thumbnails or links of documents or web pages which explain persons, objects, or events, may be thumbnails or web pages of images, moving pictures, and sound clips. In another example, the data to be displayed may be clip arts, patterns, or designs. In this case, the visual display, that is, the icon, may be thumbnails of patterns of the corresponding clip arts, patterns, fabrics, or wallpapers.

In the three-dimensional matrix of the present invention, icons of data classified by three attributes sharing specific features may be arranged in each cell having coordinate components of a horizontal axis position (X), a vertical axis position (Y), and an azimuth (φ) corresponding to the three attributes.

The arranged data may be data searched through a query or a search word within a general DB, and may also be data which have been previously arranged in a predefined form for the purpose of three-dimensional display.

Examples of the previously arranged data may include a dinosaur encyclopedia exemplifying a lot of dinosaurs, and an illustrated plant book showing photographs and explanations of several hundred kinds of plants. A lot of dinosaur entries included in the dinosaur encyclopedia may be classified into diverse common features, such as a dietary life, an emergency/extinction era, a size, and a distribution. The three-dimensional displaying method of the present invention classifies these features based on three classification attributes corresponding to a horizontal axis, a vertical axis, and an azimuth. For example, as illustrated in FIG. 1A, several evolution phases may be allocated to the horizontal axis component, and the classification based on the chronicles such as the Triassic period, the Jurassic period, and the Cretaceous period may be allocated to the vertical axis component.

Also, the classification based on the shapes of dinosaurs, such as a graminivorous land dinosaur, a carnivorous land dinosaur, a pterodactyl, an ichthyosaur, and a plesiosaur, may be allocated to the azimuth component.

In FIG. 1A, the azimuth component includes six classifications, and first to sixth half-planes are formed at 0 degree, 60 degrees, 120 degrees, 180 degrees, 240 degrees, and 300 degrees, respectively. Dinosaur entries belonging to the dinosaur shape classification based on the evolution stages are arranged at each half-plane in a horizontal axis direction. Dinosaur entries belonging to the dinosaur shape classification based on the chronicles are arranged at each half-plane.

There is no limitation on the types of data to which the three-dimensional displaying method of the present invention can be applied. For example, plants included in a plant catalog can be displayed according to the three-dimensional displaying method of the present invention.

In FIG. 1B, plant entries in the plant catalog may be classified into diverse features, such as species classification, a style, type of flower, price, age, and grade. These features may be classified based on the classification criterions corresponding to a horizontal axis, a vertical axis, and an azimuth. For example, the classification based on the grade of the plant may be allocated to the horizontal axis component, and the classification based on the age of the plant may be allocated to the vertical axis component. Also, the kind of the plant may be allocated to the azimuth component.

In addition, data having attributes which can be arranged within one concept, for example, movie data, biographic data of entertainers, photograph data, conditionally searched items of online shopping malls, may be displayed three-dimensionally and used in the searching and browsing.

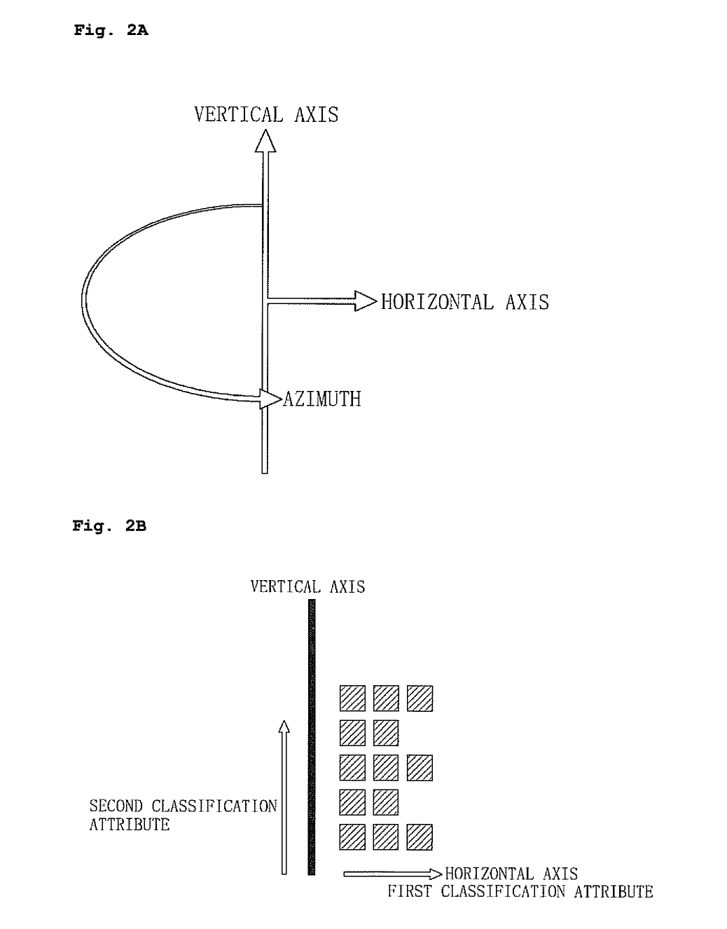

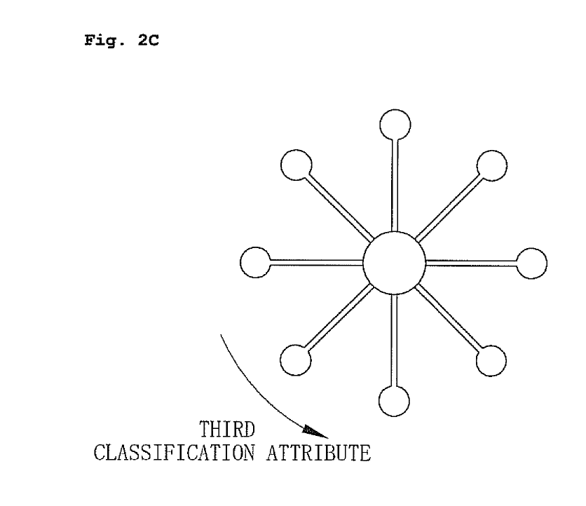

FIGS. 2A, 2B and 2C are conceptual diagrams explaining the three-dimensional displaying method in accordance with the embodiment of the present invention.

Referring to FIG. 2A, in a three-dimensional matrix frame, first classification attributes, second classification attributes, and third classification attributes are allocated to a horizontal axis, a vertical axis, and an azimuth, respectively. The first classification attributes and the second classification attributes may be grouped as the common upper-level concept. For example, in the dinosaur encyclopedia data, the common upper-level concept of the first classification attributes is the evolution stage of the dinosaurs, and the common upper-level concept of the second classification attributes is the flourishing chronicles of the dinosaurs.

The first classification attributes and the second classification attributes may be arranged within their upper-level concepts in a certain order, for example, in an ascending or descending order. For example, when the flourishing chronicles of the dinosaurs are the second classification attributes, they may be arranged in sequence from the oldest chronicle.

Referring to FIG. 2B, one of the half-planes arranged at each azimuth is illustrated as one example. On the half-plane, data entries having one of the third classification attributes arranged. Data entries represented by icons are arranged according to the first classification attribute (horizontal axis) and the second classification attribute (vertical axis).

When the half-planes are configured, they are arranged around the vertical axis along the appropriate azimuth. FIG. 2C illustrates the arrangement of the half-planes around the vertical axis along each azimuth, when viewed at the vertical axis.

In some embodiments, the first classification attributes, the second classification attributes, and the third classification attributes may be directly selected by the user, or may be mechanically determined according to the characteristic of the searched data.

For example, in the case of the searched data of the online shopping mall, the third classification attributes may be several kinds of goods groups selected by a purchaser. Regarding each goods group, the upper-level concept of the first classification attributes may be a price, and the upper-level concept of the second classification attributes may be grads of purchasers. Therefore, the searched data entries of the online shopping mall may be arranged in order from low-grade goods to high-grade goods on the horizontal axis in a direction from inside to outside. Also, the searched data entries of the online shopping mall may be arranged in order from low-price goods to high-price goods on the vertical axis in a direction from bottom to top. The goods searched from the goods group may be arranged within each half-plane in the above-described manner.

If the data entries intend to be arranged as illustrated in FIGS. 2A, 2B and 2C, the data entries for the three-dimensional display may be configured from the beginning, or the data entries for the three-dimensional display may be extracted from the search result having a plurality of attribute values through the attribute classification.

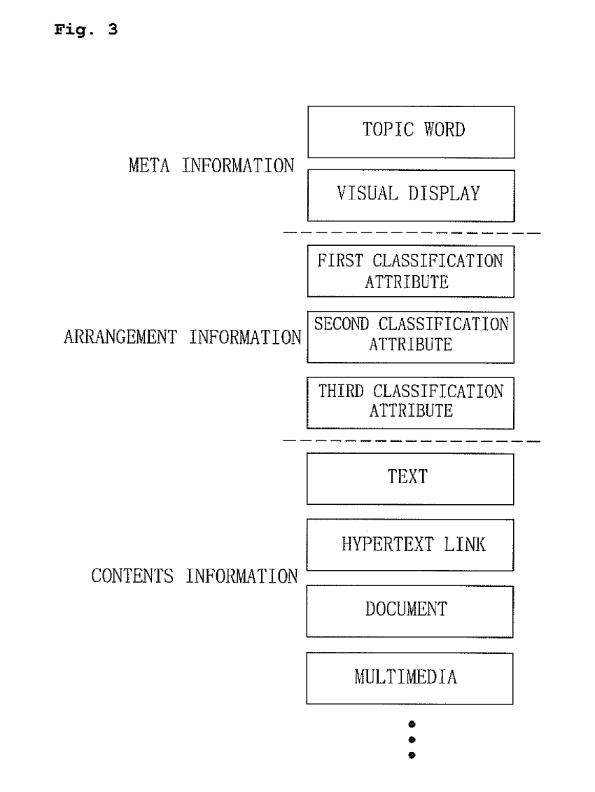

FIG. 3 is an exemplary diagram illustrating the structure of data entry for the three-dimensional data display in accordance with the embodiment of the present invention.

Referring to FIG. 3, each data entry may be structured with meta information, arrangement information, and contents information.

The meta information may include a topic word and visual display. The meta information is information used for the user's browsing. The topic word may be a word, a phrase, a paragraph, or a short sentence, which can represent the corresponding data entry. The visual display may be a two-dimensional icon or a three-dimensional shape, which can represent the corresponding data entry. For example, when the dinosaur encyclopedia is displayed on the screen three-dimensionally, the topic word may be a word “tyrannosaur”, and the visual display may be an icon embodied in a tyrannosaur shape.

In some embodiments, the topic word may be two or more words, and the visual display may also be two or more icons. For example, a certain topic word may be expressed in Korean language, foreign language, technical term, legal term, scientific term, slang, informal term, nickname, pet name, or dead language. The visual display may include different icons according to a resolution of a display a network bandwidth, or other conditions, or may include different icons associated with characteristic of the topic word.

The meta information may be displayed when the user browses the three-dimensional data matrix display. For example, the topic word may be displayed on a two-dimensional auxiliary display area, and the visual display may be displayed on a cell disposed on a half-plane of the three-dimensional display.

Meanwhile, the arrangement information is information for arranging the data entries. The arrangement information may have values of the first classification attribute, the second classification attribute, and the third classification attribute. The coordinates of the data entries may be determined within the three-dimensional matrix according to the designated arrangement information.

In the arrangement information, the values of the first classification attribute, the classification attribute, and the third classification attribute may be designated so that the data entries can be previously arranged as such. Furthermore, when the arrangement information is applied to a general DB, the DB search result is analyzed to extract a plurality of classification attributes at each search data entry. The upper-level concepts which are common to the classification attributes of the different data entries are found. Then, the classification attributes belonging to the two upper-level concepts among the found upper-level concepts are set as the first classification attribute and the second classification attribute, and the others are set as the third classification attribute.

Finally, the contents information may include information, such as a text, a hypertext, a document, a photograph, or other multimedia, which explains the corresponding data entry. For example, the contents information included in the “tyrannosaur” data entry may be a text of an encyclopedia, a photograph, and a reference link.

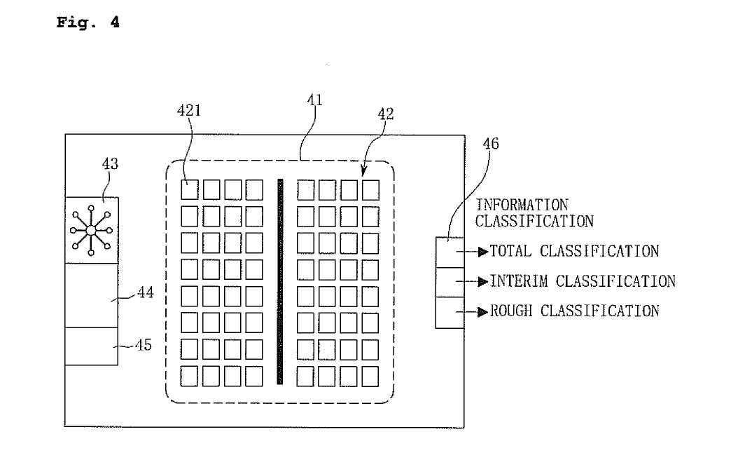

FIG. 4 is an exemplary diagram illustrating the three-dimensional data matrix display and the two-dimensional auxiliary display in accordance with the embodiment of the present invention.

Referring to FIG. 4, a three-dimensional matrix 42 is disposed at a three-dimensional display area 41 in the center of a screen. Two-dimensional auxiliary display areas 43 to 46 are disposed around the third-dimensional matrix 42 in order to increase the search and browsing efficiency. In some embodiments, the three-dimensional matrix 42 may be rotated at a predetermined speed to allow the user to browse the three-dimensional matrix 42 as a whole. Also, the user may rotate the three-dimensional matrix 42 at an arbitrary angle and in an arbitrary direction by dragging it using a mouse or the like.

Although cells 421 disposed at the coordinates of the half-planes of the three-dimensional matrix 42 are formed in a square shape, the invention is not limited thereto. For example, the cells 421 may be formed in a circular plane figure or a three-dimensional structure such as a sphere.

Furthermore, although the cells 421 having the same size are illustrated, they may be differently viewed according to perspective. However, in some embodiments, the sizes of the cells 421 may be different. For example, the dimension of the cells 421 may be increased in proportion to the number of duplication, importance, and search accuracy of the searched data.

One or more two-dimensional display areas 43 to 46 may be formed around the three-dimensional matrix display area 41 in order for smooth browsing of the three-dimensional matrix 42.

For example, a display mode selection window 43 is disposed on the left of the three-dimensional matrix 42 to selectively hide or display the half-planes of the three-dimensional matrix 42. In addition, when the user selects a visual display (i.e., an icon) disposed at a certain cell 421 of the three-dimensional matrix 42 (for example, the user clicks a mouser cursor on the cell 421 or puts a mouse cursor on the cell 421), meta information display windows 44 and 45 are further displayed. The meta information display windows 44 and 45 display meta information of the data entries disposed at the selected cell, that is, a topic word and a icon image.

A depth selection window 46 is displayed on the right of the three-dimensional matrix 42. The depth selection window 46 can allow the user to select the classification depth of the three-dimensional matrix 42. For example, the depth selection window 46 includes buttons which can allow the user to select a total classification, an interim classification, and a rough classification. When the user selects the total classification, all data entries to be displayed are displayed on the three-dimensional matrix 42. When the user selects the interim classification or the rough classification, the data entries whose number is reduced are arranged and displayed on the three-dimensional matrix 42. For example, when the user selects the interim classification or the rough classification, a part of the second classification attributes on the vertical axis may be displayed stepwise, or the cells may be selectively displayed according to importance thereof.

Furthermore, although not illustrated in the drawing, two-dimensional supplementary information display areas may be further prepared to display supplementary information, such as a search word used to generate the currently displayed three-dimensional matrix 42, the number of the searched data entries, the number of the data entries displayed on the three-dimensional matrix, statistics such as accuracy, and partial contents information.

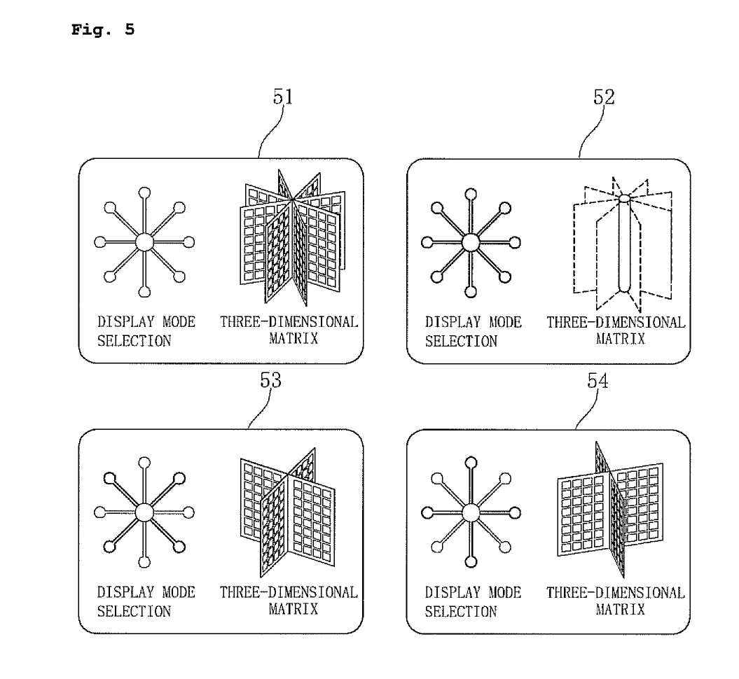

FIG. 5 illustrates exemplary display modes of the three-dimensional matrix in accordance with the embodiment of the present invention.

FIG. 5 illustrates the display modes 51 to 54 of the three-dimensional matrix when the user selects the display/non-display of each half-plane on the display mode selection window.

First, the left upper portion 51 of FIG. 5 is an exemplary diagram illustrating the three-dimensional matrix displayed when the user selects to display all half-planes. Since all half-planes are displayed, it may be difficult to distinguish the icons if too many icons are displayed.

The right upper portion of FIG. 5 is an exemplary diagram illustrating the three-dimensional matrix displayed when the user deselects all half-planes. The left and right lower portions of FIG. 5 are exemplary diagrams illustrating the three-dimensional matrix displayed when the user deselects some of the half-planes.

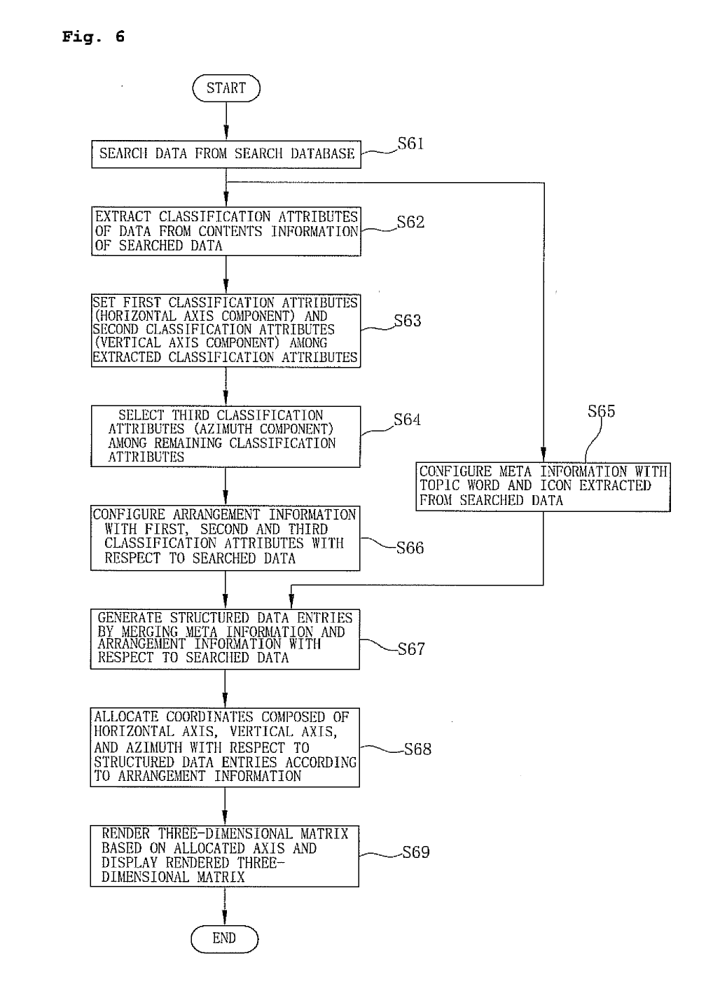

FIG. 6 is a flowchart illustrating a method for structuring searched data and generating a three-dimensional matrix in order for three-dimensional display in accordance with an embodiment of the present invention.

Referring to FIG. 6, data are searched from a search database at step S61.

At step S62, at least three classification attributes of the corresponding data are extracted from contents information of the searched data. For example, classification attributes may be extracted from description information included in data “tyrannosaur” searched based on a search word “dinosaur”, wherein the classification attributes include the contents that the corresponding dinosaur is the tyrannosaur family dinosaur, the carnivorous dinosaur, the land dinosaur, and the erect dinosaur, lived during the Jurassic period, and had a height of 10 m or more and a weight of 5 tons or more. Similarly, classification attributes may also be extracted from other searched data.

At step S63, the classification attributes having the common upper-level concept among the extracted classification attributes are analyzed, and the classification attributes belonging to two upper-level concepts selected among the common upper-level concepts are set as the first classification attributes (horizontal axis component) and the second classification attributes (vertical axis component). For example, two upper-level concepts which are most widely common may be selected. In this case, the first classification attributes and the second classification attributes may be arranged within their upper-level concepts in a certain order, for example, in an ascending or descending order.

At step S64, the classification attributes which are partially common to the data entries among the remaining classification attributes are selected as the third classification attributes (azimuth). For example, when a set A of data entries has the first classification attribute and the second classification attribute and also has the classification attribute A, and a set B of other data entries has the first classification attribute and the second classification attribute but has the classification attribute B rather than the classification attribute A, the classification attribute A may be set as the third classification attribute of the set A, and the classification attribute B may be set as the third classification attribute of the set B.

At steps S63 and S64, a three-dimensional matrix frame is generated.

At step S65, a topic word and an icon are extracted from the searched contents with respect to the data searched at step S61, and meta information is configured with the extracted topic word and icon.

At step S66, arrangement information is configured with the first, second and third classification attributes of the searched data according to the first, second and third classification attributes set at steps S63 and S64.

At step S67, the meta information of step S65 and the arrangement information of step S66 with respect to the searched data are merged to generate structured data entries.

At step S68, coordinates composed of a horizontal axis, a vertical axis, and an azimuth are allocated to the structured data entries.

At step S69, the three-dimensional matrix is rendered based on the allocated coordinates and displayed on the screen.

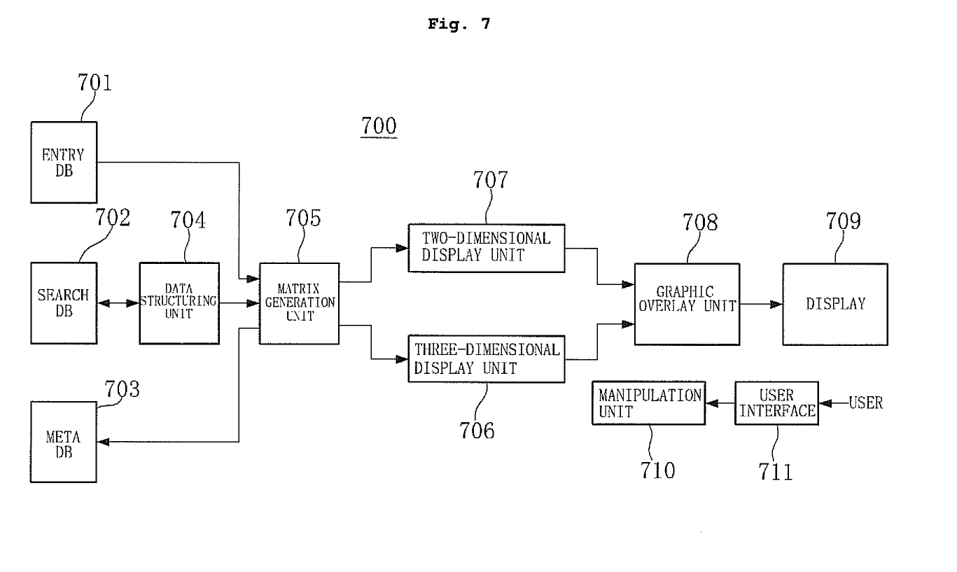

FIG. 7 is a schematic block diagram illustrating a three-dimensional data displaying system in accordance with an embodiment of the present invention.

Referring to FIG. 7, the three-dimensional data displaying system 700 may include an entry DB 701, a search DB 702, a meta DB 703, a data structuring unit 704, a matrix generation unit 705, a three-dimensional display unit 706, a two-dimensional display unit 707, a graphic overlay unit 708, a display 709, a manipulation unit 710, and a user interface 711.

The operation of the three-dimensional displaying system 700 starts with the step of extracting data entries for three-dimensional display from the DBs 701 and 702 at the data structuring unit 704 according to the user's instruction.

The entry DB 701 includes data entries structured to be displayed on the three-dimensional matrix. The data entries included in the entry DB 701 include meta information containing a topic word and an icon, arrangement information having classification attribute information for arrangement in the three-dimensional matrix, and contents information.

The search DB 702 is a typical DB which returns a search result by a search query. Such a search result cannot be displayed on the three-dimensional matrix in this state.

The meta DB 703 stores and manages the meta information of the data entries, which are searched by the user at least one time, together with the search word. When the user again inputs the same search word, the meta information based on the search word is searched from the meta DB 703, and thus, the speed which displays the search result on the three-dimensional matrix can be accelerated. Furthermore, secondarily, information such as frequent search words and interests can be processed by analyzing the meta DB 703.

The data structuring unit 704 may analyze the search result provided from the search DB 702, and process the search result into structured data entries. For example, the data structuring unit 704 may extract classification attributes of the searched data provided from the search DB 702, find upper-level concepts which are common to classification attributes of different data entries, set classification attributes belonging to two upper-level concepts among the found upper-level concepts as the first classification attribute and the second classification attribute, and set the remaining classification attributes as the third classification attribute. In this manner, the data structuring unit 704 may generate arrangement information with the first, second and third classification attributes corresponding to the searched data, generate the meta information with the topic word and the icon extracted from the contents information of the searched data, and generate structured data entries including the meta information, the arrangement information, and the contents information.

The matrix generation unit 705 receives the data entries from the entry DB 701 or the structured data entries from the data structuring unit 704, and allocates coordinates of the three-dimensional matrix to the data entries according to the arrangement information included in the data entries. The matrix generation unit 705 transfers the meta information and coordinates of the data entries, to which the coordinates are allocated, to the three-dimensional display unit 706 and the two-dimensional display unit 707.

The three-dimensional display unit 706 renders the three-dimensional matrix image in which icons are arranged according to the coordinates. The two-dimensional display unit 707 renders two-dimensional auxiliary display which displays meta information according to the coordinates of the cell selected by the user.

The three-dimensional matrix image of three-dimensional display unit 706 and the two-dimensional auxiliary display of the two-dimensional display unit 707 are synthesized by the graphic overlay unit 708 and displayed on the display 709.

The user may input a manipulation command through the user interface 711, and the manipulation unit 710 may control the operation of each element according to the inputted manipulation command.

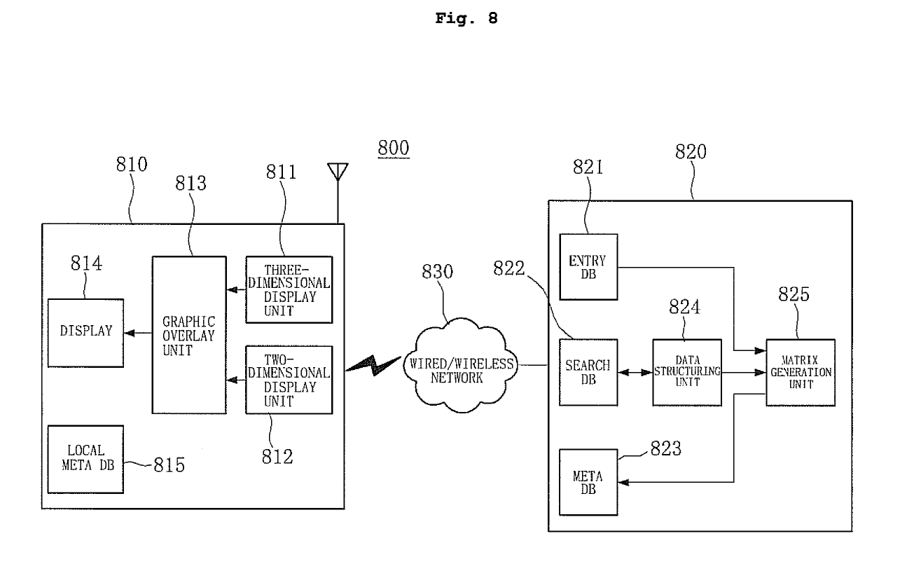

FIG. 8 is a system diagram illustrating a three-dimensional mobile search data displaying system in accordance with an embodiment of the present invention.

Referring to FIG. 8, the three-dimensional mobile search data displaying system 800 includes a terminal 810, a search server 820, and a wired/wireless network 830.

The terminal 810 allows the user to input the search word and view the three-dimensional matrix display of the search result. The terminal 810 may include a three-dimensional display unit 811, a two-dimensional display unit 812, a graphic overlay unit 813, a display 814, and a local meta DB 815. The three-dimensional display unit 811 renders the three-dimensional matrix image according to the meta information and coordinates received through the search server 820, and the two-dimensional display unit 812 renders the two-dimensional auxiliary display according to the meta information. The graphic overlay unit 813 synthesizes the three-dimensional matrix image of the three-dimensional display unit 811 and the two-dimensional auxiliary display of the two-dimensional display unit 812, and displays the synthesized image. In addition, the local meta DB 814 may be generated and managed according to the reception of the search result. Thus, the user's search result can be stored and managed in order for future utilization.

The search server 820 may provide a search service to a user connected through the terminal 810. The search server 820 may include an entry DB 821, a search DB 822, a meta DB 823, a data structuring unit 824, and a matrix generation unit 825.

The data structuring unit 824 structures the previously structured data entries provided from the entry DB 821, or the data searched from the search DB 822 by the structuring method in accordance with the embodiment of the present invention, and provides the structured data entries to the matrix generation unit 825. The matrix generation unit 825 allocates coordinates to the data entries. The search server 820 transfers the meta information, the coordinates, and the contents information of the data entries to the terminal 810 through the wired/wireless network 830. The meta information of the searched and structured data entries may be stored in the meta DB 823 in order for future utilization.

In accordance with the embodiments of the present invention, a large amount of searched data can be displayed three-dimensionally on a single screen of a PC, a web, or a mobile device, and the user can easily browse a large amount of searched data displayed on the three-dimensional matrix and easily select a specific data entry.

While the present invention has been described with respect to the specific embodiments, it will be apparent to those skilled in the art that various changes and modifications may be made without departing from the spirit and scope of the invention as defined in the following claims.

The invention can also be embodied as computer readable codes on a computer-readable storage medium. The computer-readable storage medium is any data storage device that can store data which can be thereafter read by a computer system. Examples of the computer-readable storage medium include ROMs, RAMs, CD-ROMs, DVDs, magnetic tapes, floppy disks, registers, buffers, optical data storage devices, and carrier waves (such as data transmission through the Internet). The computer-readable storage medium can also be distributed over network coupled computer systems so that the computer readable codes are stored and executed in a distributed fashion.

What is claimed is:

1. A three-dimensional data displaying method comprising:
rendering a three-dimensional matrix image by arranging meta information representing data entries at coordinates composed of a horizontal axis component, a vertical axis component, and an azimuth component, based on arrangement information, with respect to structured data entries including the meta information and the arrangement information; and
displaying the three-dimensional matrix on a screen.

2. The three-dimensional data displaying method of claim 1, wherein the meta information comprises a topic word and a visual display, and the arrangement information comprises a first classification attribute corresponding to the horizontal axis component, a second classification attribute corresponding to the vertical axis component, and a third classification attribute corresponding to the azimuth component.

3. The three-dimensional data displaying method of claim 2, further comprising:
searching data; and
processing the searched data into the structured data entries, based on the classification attributes of the searched data.

4. The three-dimensional displaying method of claim 3, wherein the processing of the structured data entries comprises:
extracting at least three classification attributes with respect to the searched data;
extracting common upper-level concepts with respect to the extracted classification attributes;
setting the classification attributes, which belong to two most common upper-level concepts among the extracted upper-level concepts, as first classification attributes corresponding to a horizontal axis component and second classification attributes corresponding to a vertical axis component; and
setting the classification attributes, which belong to a plurality of partially common upper-level concepts among the remaining classification attributes, as a third classification attribute corresponding to an azimuth component.

5. The three-dimensional data displaying method of claim 2, wherein the three-dimensional matrix is visualized so that visual information among the meta information is disposed at the coordinates, and the three-dimensional data displaying method further comprises displaying visual information and a topic word among the meta information on an auxiliary display area with respect to coordinates a user selects in the three-dimensional matrix.

6. A three-dimensional data displaying system comprising:
a matrix generation unit configured to allocate coordinates composed of a horizontal axis component, a vertical axis component, and an azimuth component, based on arrangement information, with respect to structured data entries including meta information and the arrangement information; and
a three-dimensional display unit configured to render a three-dimensional matrix image by arranging the meta information representing the data entries at the coordinates.

7. The three-dimensional data displaying system of claim 6, wherein the meta information comprises a topic word and a visual display, and the arrangement information comprises a first classification attribute corresponding to the horizontal axis component, a second classification attribute corresponding to the vertical axis component, and a third classification attribute corresponding to the azimuth component.

8. The three-dimensional data displaying system of claim 7, further comprising an entry database including the structured data.

9. The three-dimensional data displaying system of claim 7, further comprising:
a search database; and
a data structuring unit configured to process the searched data into the structured data entries, based on the classification attributes of the data searched from the search database.

10. The three-dimensional displaying system of claim 9, wherein the data structuring unit is configured to extract at least three classification attributes with respect to the searched data, extract common upper-level concepts with respect to the extracted classification attributes, set the classification attributes, which belong to two most common upper-level concepts among the extracted upper-level concepts, as first classification attributes corresponding to a horizontal axis component and second classification attributes corresponding to a vertical axis component, and set the classification attributes, which belong to a plurality of partially common upper-level concepts among the remaining classification attributes, as a third classification attribute corresponding to an azimuth component.

11. The three-dimensional data displaying system of claim 7, wherein the three-dimensional matrix is visualized so that visual information among the meta information is disposed at the coordinates, and the three-dimensional data displaying system further comprises a two-dimensional display unit configured to display visual information and a topic word among the meta information on an auxiliary display area with respect to coordinates a user selects in the three-dimensional matrix.

12. A three-dimensional data displaying system comprising:
a server including a matrix generation unit configured to allocate coordinates composed of a horizontal axis component, a vertical axis component, and an azimuth component, based on arrangement information, with respect to structured data entries including meta information and the arrangement information; and
a three-dimensional display unit configured to render a three-dimensional matrix image by arranging the meta information representing the data entries at the coordinates.
